(19) United States
(12) Patent Application Publication
(10) Pub. No.: US 2004/0036240 A1
(43) Pub. Date: Feb. 26, 2004

(54) Cart bag

(76) Inventor: Yu-Feng Chen, Taipei (TW)

Correspondence Address: YU-FENG CHEN, P.O. Box 26-757, TAIPEI, 106, TW

(21) Appl. No.: 10/229,621

(22) Filed: Aug. 26, 2002

(51) Int. Cl. B62B 1/10

(52) U.S. Cl. 280/47.26

(57) ABSTRACT

A cart bag is constructed to include a bag body, two wheels bilaterally pivoted to the bottom side of the bag body adjacent to the back side, and a handle provided at the front side of the bag body remote from the wheels for letting the center of gravity of the cart bag be lowered when carried by the user on the floor.

### BACKGROUND OF THE INVENTION

1. Field of the Invention

The present invention relates to a cart bag and, more particularly, to such a cart bag that has a low center of gravity so that the cart bag to be moved on the floor more stably.

2. Description of the Related Art

A regular cart bag 10, as shown in FIG. 1, comprises a bag body 101, a handle 102, and a pair of wheels 103. The handle 102 is provided at the back side of the bag body 101. The wheels 103 are bilaterally pivoted to the bottom side of the bag body 101 near the back side. When pulling the handle 102 to move the cart bag 10 on the floor, the center of gravity of the cart bag 10 is concentrated at an upper part of the bag body 101. Therefore, the cart bag 10 tends to turn over when moved over an uneven road surface or a hole in the road.

### SUMMARY OF THE INVENTION

The present invention has been accomplished under the circumstances in view. It is the main object of the present invention to provide a cart bag, which has a low center of gravity when tilted and carried on the floor by the user. It is another object of the present invention to provide a cart bag, which maintains stable when carried on the floor by the user. To achieve these and other objects of the present invention, the cart bag comprises a bag body, two wheels bilaterally pivoted to the bottom side of the bag body adjacent to the back side, and a handle provided at the front side of the bag body remote from the wheels for letting the center of gravity of the cart bag be lowered when carried by the user on the floor. Because the handle is provided at the front side of the bag body remote from the wheels, the center of gravity of the cart bag is low when the cart bag tilted and carried on the floor by the user.

### BRIEF DESCRIPTION OF THE DRAWINGS

FIG. 1 illustrates a cart bag according to the prior art.

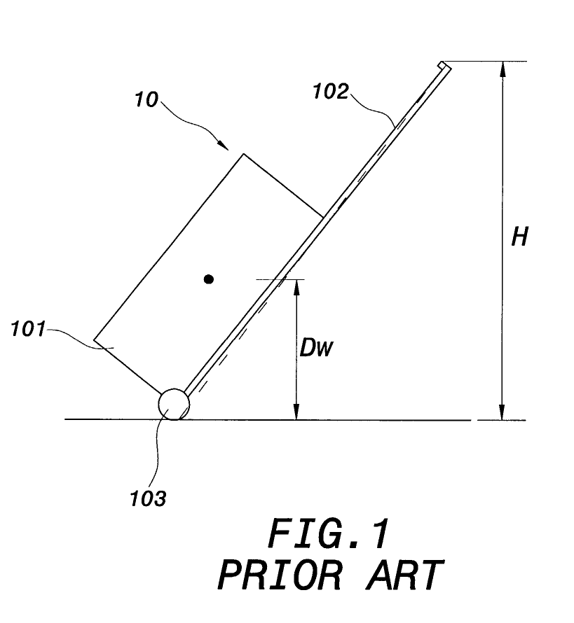

FIG. 2 is a side view of a cart bag according to the first embodiment of the present invention.

FIG. 3 is a side view of a cart bag according to the second embodiment of the present invention.

FIG. 4 is a side view of a cart bag according to the third embodiment of the present invention.

### DETAILED DESCRIPTION OF THE PREFERRED EMBODIMENT

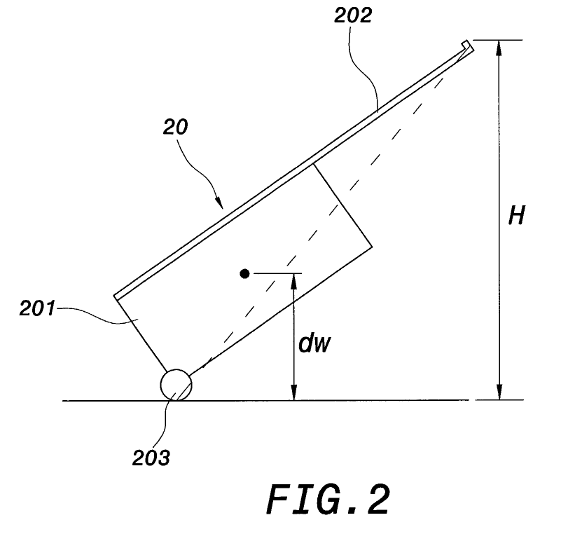

Referring to FIG. 2, a cart bag 20 in accordance with the present invention is shown comprised of a bag body 201, a handle 202, and two wheels 203. The wheels 203 are bilaterally pivoted to the bottom side of the bag body 201 near the back side. The handle 202 is provided at the front side of the bag body 201. Because the handle 202 is provided at the front side of the bag body 201 remote from the wheels 203, the center of gravity of the cart bag 20 is greatly lowered, enabling the cart bag 20 to be moved on the floor stably. Further, because the center of gravity of the cart bag 20 is greatly lowered, the arm of force on the fulcrum at one of the wheels 203 is relatively shortened, resulting in a short moment of gyration when turning the cart bag 20 to change the steering direction.

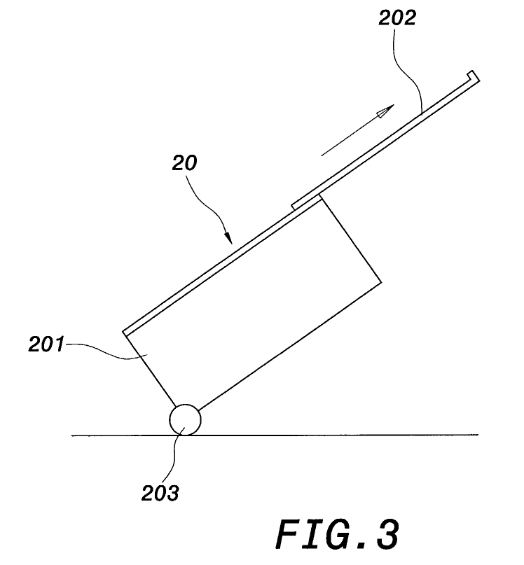

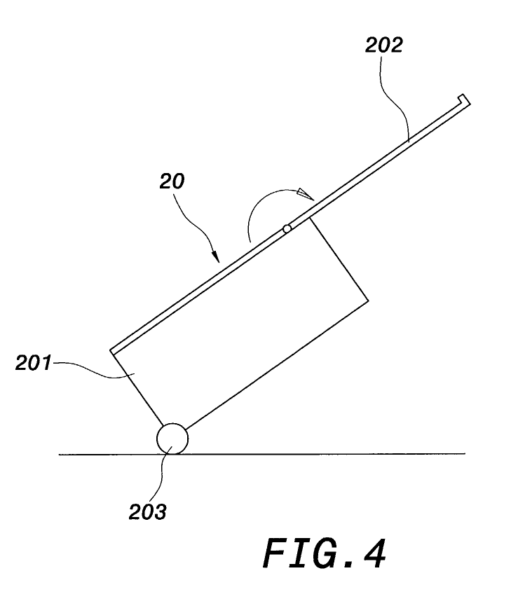

Referring to FIGS. 3˜4, the handle 202 may be variously embodied. According to the embodiment shown in FIG. 3, the handle 202 is a retractable handle. According to the embodiment shown in FIG. 4, the handle 202 is a foldable handle that can be folded up when not in use, or extended out when in use.

A prototype of cart bag has been constructed with the features of FIGS. 2˜4. The cart bag functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A cart bag comprising a bag body, a pair of wheels bilaterally pivoted to a bottom side of said bag body and adjacent to a back side of said bag body, and a handle provided at a front side of the bag body remote from said wheels, whereby a center of gravity of the cart bag can be lowered for improving the stability thereof.

2. The cart bag as claimed in claim 1, wherein said handle is a retractable handle.

3. The cart bag as claimed in claim 1, wherein said handle is a folding handle.
